(19) United States
(12) Patent Application Publication
(10) Pub. No.: US 2024/0417658 A1
(43) Pub. Date: Dec. 19, 2024

(54) Methods for Electronically Modifying Alcoholic Beverages

(71) Applicant: Steric Systems Inc., Culver City, CA (US)

(72) Inventors: Steven Gary Goldstein, Los Angeles, CA (US); Eric Bergerson, Los Angeles, CA (US); Kevin David Jordan, Culver City, CA (US)

(21) Appl. No.: 18/334,374

(22) Filed: Jun. 13, 2023

(51) Int. Cl. C12G 3/08; A23L 5/30; C12G 1/00; H03K 3/017

(52) U.S. Cl. CPC C12G 3/08; A23L 5/30; C12G 1/00; H03K 3/017

(57) ABSTRACT

The present invention discloses a method for processing an alcoholic beverage in a way that makes the alcohol taste better while taking a minimal amount of time to do so. The method accomplishes this by briefly subjecting the liquid in a container or a tank to a pulse-width modulated EM field having certain characteristics, such as a predetermined average voltage, a duty cycle, fundamental frequency and harmonics thereof and for a determined or certain amount of a time, often in the milliseconds to seconds range. Changing these parameters have a demonstrated greater effect on some compounds in alcoholic beverages than others.

### RELATED APPLICATIONS

None.

### BACKGROUND OF THE INVENTION

The present invention pertains to the field of alcoholic beverages and in particular to processes for rapidly modifying the taste of spirits and wines.

Historically, a great deal of effort has been expended researching, experimenting, and finding ways to improve the often harsh, astringent taste of alcoholic beverages such as naturally fermented and distilled beverages like wine and spirits. The goal is to adjust the taste and smell profiles of these beverages in ways that make them more enjoyable to drink. While some of these taste-improving processes are notoriously slow (can take years), others look to achieve improvements very fast, even in seconds.

For example, the aging of alcoholic beverages is a well-known but complex process that involves several chemical reactions and by definition is a slow process. As a wine ages in wooden barrels, the sugars, acids, ketones & aldehydes, esters and phenols react with one another to cause changes that generally make the wine more pleasurable to drink. These chemical reactions can transform a harsh, astringent, simply fruity wine into a smooth, aromatic beverage with complex flavors.

The two stages of wine aging are maturation and reductive aging. Maturation, the changes that occur between alcoholic fermentation and bottling, generally takes between six months to two years, but extend to a decade for some wines. Traditionally, wine matures in closed oak barrels with some oxygen reaching the wine by diffusion through the wood. The winemaker will sometimes raise the pH of the wine during maturation by employing malolactic fermentation. In the reductive aging, wine is stored in the bottle with minimal oxygen diffusion through the cork.

Likewise for grain and fruit-derived spirits, such as vodka, scotch and bourbon. As a general rule, the longer the spirits ages (usually in a barrel), the softer and more complex its nose and taste. For example, relatively inexpensive, non-aged pure grain alcohol, which is fermented sugar derived from grain and then distilled, has a very high and astringent alcohol content and is difficult to drink straight up. Thus, it is used as a base for many flavored or mixed alcohol beverages, including liquors and hard seltzers. By contrast, at the high and expensive end, a single malt scotch or a bourbon that has matured in a high quality French oak barrel for 25 years, for example, will generally be more desirable and fetch a much higher price than that same scotch aged only 5 or 10 years.

Accordingly, myriad “rapid aging” technologies and techniques have been tried and employed with the goal of mimicking the natural aging process in a compressed period of time to thereby improve the taste profile of unaged or less aged alcoholic beverages of all qualities and types. Rapid aging thus tries to accelerate the aging process of these beverages, which would otherwise take years to achieve and has long been tried to achieve better taste. The most common methods of rapid aging involve exposing the beverage to gases, heat, vacuum and pressure, which can simulate the conditions that the beverage would experience during traditional aging. This process can help to enhance the flavor, aroma, and color of the beverage in a shorter period of time.

Other rapid aging methods include irradiating spirits with electromagnetic energy having various wavelengths, whether in visible, ultraviolet or ultrasound ranges.

However, many of these methods have been met with skepticism and are not widely employed. Some experts argue that conventional rapid aging techniques result in flavors that are too harsh or unbalanced, as the process may not allow for the same subtle and nuanced changes that occur during traditional aging. Furthermore, while rapid aging obviously eliminates the costs and risks associated with long term storage of aging beverages, these techniques can be expensive and cumbersome, and may not always produce consistent results. As such, many producers continue to rely on age-old aging methods to create the highest quality alcoholic beverages.

Accordingly, what is needed is a solution that rapidly—and in some cases almost instantaneously-processes raw alcoholic beverages in volume in a way that does not suffer from the drawbacks of conventional methods and truly improves the taste and mouthfeel of these beverages.

The present invention addresses these needs and more.

### SUMMARY OF THE INVENTION

The inventors of the present invention recognized that a solution to the problem of rapidly improving alcohol flavor profiles may not lie in attempting to mimic or compress the conventional aging process. Rather, the process of the present invention employs the application of a specific, complex electromagnetic waveform to a volume of liquid for a determined, usually very brief, period of time to electrically target and remove chemical components of the fluid and to thereby improve its flavor profile.

The method of preferred embodiments of the present invention employs an alcoholic beverage processing system comprising an electrically isolated processing chamber in which the processing takes place. The body of the processing chamber is made of a conductive material which serves as one electrode, and suspended in the center of the chamber is a second electrode encased in a non-conductive material. A control circuit controls a high voltage electromagnetic processing signal, monitors the flow of the liquid, and controls valves and pumps for moving the liquid in, through and out of the system.

The liquid to be processed is preferably first fed into the system input pipe and is propelled by an external pump or suctioned by an internal pump attached to the system, or propelled by gravity from a liquid source located higher than the input pipe. The liquid proceeds through the input pipe until it reaches a processing tank input valve which controls the flow of liquid into the processing tank. The processing tank input valve remains closed until commanded to open by the control circuit which then allows the processing tank to fill. Sensors attached to the processing tank monitor the liquid level within the processing tank and close the processing tank inlet valve when the tank is filled to the desired level.

A high voltage processing signal is generated and sent for a selected amount of time to the electrode lead connected to the exterior of the tank and the electrode lead connected to the center electrode located in the electrically isolated non-conductive cylinder in the middle of the tank. After the desired processing time elapses, the high voltage signal is turned off and relays reconnect the tank liquid level sensors to the control circuitry.

The control circuit may then direct a drain valve located at the bottom of the processing tank to open. In gravity operated processing systems, the liquid drains from the processing tank until the tank is empty as determined by the time the drain valve remains open. On pump drained systems, a pump may suck the liquid from the processing tank until sensors located in the tank drain pipe determine the tank is empty.

Once the processing tank is empty, the control system opens the processing tank input valve to receive more unprocessed liquid and the process repeats itself.

Thus, in embodiments of the present invention, a novel method of processing an alcoholic beverage is disclosed. The method comprises the steps of first placing a first volume of the beverage in a container having two electrodes, wherein the volume is positioned substantially between the electrodes, with at least one of the electrodes being electrically insulated from the volume. The method then employs the step of generating an electromagnetic (EM) field between the electrodes to subject the volume to the EM field, wherein the EM field comprises a complex waveform having a pulse-width-modulated fundamental frequency and multiple harmonics derived therefrom. This EM field is maintained for a certain amount of time.

In embodiments, the method further includes the step of removing the first volume from the container after the certain amount of time has elapsed, and then placing a second volume of the alcoholic beverage into the container and repeating steps of generating an EM field and maintaining the EM field on the second volume. This process can be repeated as many times as needed or desired.

It is to be understood that the invention is not limited in its application to the details of construction and the arrangement of components described hereinafter and illustrated in the drawings and photographs. Those skilled in the art will recognize that various modifications can be made without departing from the scope of the invention.

### BRIEF DESCRIPTION OF THE FIGURES

Further advantages of the present invention may become apparent to those skilled in the art with the benefit of the following detailed description of the preferred embodiments and upon reference to the accompanying drawings in which:

FIG. 1 is a block diagram showing hardware and fluid flow used in batch processing a beverage in accordance with one preferred embodiment of the present invention;

FIG. 2 is flow diagram showing processing steps employed by one embodiment of the present invention;

FIGS. 3A-3C are perspective diagrams showing various sides and angles of an assembled system used for performing one embodiment the present invention;

FIG. 4A is a perspective view of a preferred beverage processing tank used in the present invention;

FIG. 4B is a cross-sectional cutaway view of the tank shown in FIG. 4A; and

FIG. 5 is a chart showing changes in the composition of an alcoholic beverage before and after processing the beverage according the present invention.

### DETAILED DESCRIPTION OF THE INVENTION

The inventors of the present invention have discovered that subjecting a volume of an alcoholic beverage to an electromagnetic (EM) field having special complex waveform characteristics for a certain, usually very short amount of time can alter the chemical composition, including the amyl alcohol composition, of the beverage in ways that make the beverage more palatable and/or pleasurable to drink.

The fermentation of non-alcoholic liquids in alcoholic beverages results in the production of several types of chemical alcohols. During fermentation, yeast or bacteria break down sugars in the raw materials (such as malted barley, grapes, or molasses) and produces ethanol, the main type of alcohol found in these beverages, as well as other byproducts including isoamyl alcohols. Isoamyl alcohols are a group of long-chain isomeric alcohols with the molecular formula C5H12O. These isomers differ in the arrangement or position of atoms within the molecule. One particular such long-chain alcohol found in alcoholic beverages that the inventors have found may have a significant impact on the taste, burn and mouthfeel of many of these beverages is A-Amyl alcohol, having the following 5-carbon (pentyl ground) structure: CH3-CH2-CH2-CH2-CH2-OH, graphically shown as:

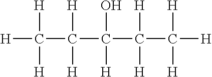

A-Amyl alcohol has a strong, pungent odor and a slightly sweet taste. It is often described as having a banana-like or fruity aroma, which can be desirable in some styles of beer or spirits. However, in higher concentrations, can also impart an unpleasant, solvent-like, or astringent taste and aroma. Indeed, it is believed that one primary factor contributing to the harsh taste of many alcoholic beverages, and particularly many high-volume, inexpensive alcohols that are not distilled many times, such as vodkas and grain alcohols, is the high concentration of A-Amyl alcohol in these drinks.

In addition to its role in the sensory properties of alcoholic beverages, A-Amyl alcohol can also impact the texture and mouthfeel of the finished product. Small amounts of this alcohol in spirits or liqueurs can enhance their body or “mouthfeel.” Too much, however, can degrade the body of the drink.

Because of the complexity of the fermentation process, the presence and concentration of isoamyl alcohols can vary depending on many factors such as the type of yeast or bacteria used, the temperature of fermentation, the specific recipe or ingredients used in the production process and the number of times the beverage is distilled, and aging, to name some. Therefore, controlling the amounts of these types of alcohols, and specifically reducing A-Amyl alcohol concentrations during the production of spirits has either not been recognized, or to the inventors' knowledge has not been tried or commercially successful, if tried.

The inventors of the present invention have discovered that generating a specific type of EM field at a relatively high voltage, namely, a complex Pulse Width Modulation (PWM) waveform having a pre-determined pulse width modulated fundamental frequency selected from a particular range of frequencies and multiple harmonics derived from that fundamental frequency, and subjecting a volume of an alcoholic beverage—and particularly spirits and wine-to this field for a very short but specific duration, can significantly enhance the flavor, aroma and mouthfeel of these beverages. The inventors have demonstrated that one mechanism of the process that affects this positive change is a distinct reduction in the Amyl, and particularly the A-Amyl, alcohol content of the volume. The Steric methods of the present invention use subtle EM complex waveform to influence the molecular structure of spirits, including the breakdown of these 5-carbon long-chain alcohols, and in particular A-Amyl alcohols, into “short-chain,” 2-carbon alcohols, such as ethanol (C2H5OH): CH3-CH2-OH, which are generally perceived as being smoother and more palatable than long-chain alcohols.

As further background, PWM is a technique conventionally used to control a power signal delivered to a load by varying the width of the pulses of a periodic waveform. In PWM, the pulse width is conventionally modulated at a constant frequency and voltage to achieve a desired power level. As is understood, the waveform resulting from conventional PWM has a fundamental frequency and harmonics of that fundamental frequency. For PWM, a constant voltage is switched on and off at a fixed frequency, with the ratio of the on-time to the off-time-known as the duty cycle-determining the average voltage level. The fundamental frequency of a PWM waveform is the frequency at which the pulse width modulation signal is changing. This frequency is typically referred to as the carrier frequency or switching frequency. (The carrier frequency is usually much higher than the frequency of the signal being modulated. The frequency of the modulating signal is referred to as the base frequency or the modulating frequency).

The harmonics of a PWM waveform are integer multiples of the fundamental frequency. They are generated because the pulse width modulation signal is not a pure sine wave, but rather a series of pulses with a finite rise and fall time. The harmonics of the PWM waveform can be found by multiplying the fundamental frequency by 2, 3, 4, and so on.

The harmonic content of a PWM waveform depends on the duty cycle of the pulses. Duty cycle is the ratio of the pulse width to the period of the carrier frequency waveform. If the duty cycle is low, the fundamental frequency component will be smaller, and the harmonic content will be higher. If the duty cycle is high, the fundamental frequency component will be larger and the harmonic content will be lower.

Referring now to the drawings, like reference numerals designate identical or corresponding features throughout the several views.

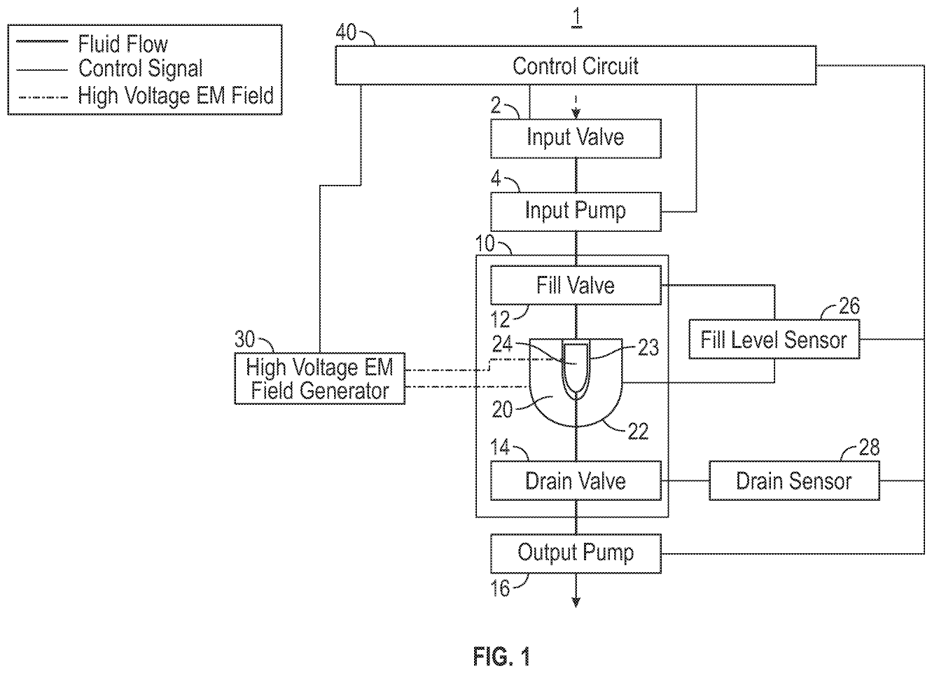

Applying these principals, the present inventive method may be implemented in preferred embodiments in a high voltage, EM PWM field-generating tank processing system 1 as diagrammatically shown in FIG. 1. System 1 is designed to batch process volumes of an alcoholic beverage by applying to each batch the generated EM field. System 1 comprises three main components: beverage-receiving tank assembly 10, EM field generator 30 and control circuit 40. Tank assembly 10 includes an electrically isolated processing chamber, or tank, 20, tank fill valve 12 and tank drain valve 14. Tank 20 has an outer conducting electrode wall 22 and inner core electrode 24 encased in a electrically isolated tube 23. Fill valve 12 that is controlled by fill level sensor 26 and drain valve 14 controlled by drain sensor 28. In preferred embodiments, an amount, potentially a large volume of pre-processed alcoholic beverage is located in a holding container (not shown) that is connected to system 1 at input valve 2, such that a certain volume of the beverage may enter tank 20. The measured tank filling may occur in any number of ways. In the embodiment shown, control circuit 40 may signal the opening of input valve 2 and activating of input pump 4 to draw in liquid to be processed from the external holding container (not shown). In this embodiment, fill valve 12 is equipped with fill level sensor 26 that actively monitors the volume of liquid entering tank 20. When sensor 26 senses that the volume in tank 20 reaches a pre-determined level (amount), in some embodiments 5 gallons, control circuit 40 sends a signal to stop input pump 4 from drawing in additional liquid and to close input valve 2. As will be understood by those skilled in the art, alternatively, the desired volume of pre-processed beverage may be metered outside of system 1, obviating the need for a fill level sensing and control subsystem.

Once the required or desired volume of pre-processed liquid is in tank 20, in preferred embodiments, the volume is allowed to come to rest or substantial rest. Control circuit 40 then activates high voltage EM field generator 30 for a set amount of time. As seen, generator 30 is electrically connected to outer conducting electrode wall 22 and electrically insulated inner core electrode 24.

In embodiments disclosed here, once the volume of liquid in tank 20 is processed by the EM field, control circuit 40 instructs drain valve 14 to open and output pump 16 to pump the processed liquid to a waiting container (not shown). When drain sensor 28 connected to drain valve 14 senses there is no more liquid to extract from tank 20, this process may repeat with the ingestion of a 2^{nd} batch of unprocessed wine or spirits. This process may be repeated for as many batches of volume as required or desired. As will be discussed further, because in preferred embodiments, the amount of time needed to subject a fairly significant amount of alcoholic beverage to the PWM waveform is so little—in the order of seconds—processing a single batch of say 5 or 8 gallons of beverage from (a) tank fill to (b) electronic processing to (c) tank emptying, can take much less than one minute. Thus, in embodiments implementing a 5-gallon tank 20, for example, thousands of gallons of beverage may be processed in a single day using a single EM PWM field-generating tank processing system 1 of the present invention.

### Generation of the Electromagnetic Field

In a preferred embodiment, EM field generator 30 creates a complex PWM waveform per the present invention between electrodes 22, 24 of tank 20, thereby subjecting substantially the entire volume of preferably resting liquid to this specialized EM field. Processing tank 20 and its electrodes are designed in such a way that will allow the electromagnetic field to completely envelope the fluid. There are several options available to this achieve uniform processing. Processing tank 20 can be made of an insulating material with electrodes applied to the surface of tank 20. Or, tank 20 may be composed of an electrically conducting material such as stainless steel, that will act as a uniform radiator. Also, tank outer wall 22 may preferably have a substantially round circumference. Thus, when the EM waves are generated, they are distributed throughout this container 20 containing the beverage via the radiators. The radiators could take many different forms and orientations. In one preferred embodiment, the field created by the radiators that the fluid is subjected to has a toroidal shape, with one radiator on the outside wall of tank 20 circumferentially surrounding the fluid while the other electrode is a vertical, concentric “core” electrode 24 jutting up from the middle of the processing tank. This structure forms an even distribution of the electromagnetic field throughout the fluid. Another form of radiator orientation within the scope of the present invention could be a vessel surrounded on all sides by radiators. The sides and the radiators can take any appropriate shape that effectively creates an EM field that uniformly, or substantially uniformly, subjects all or most of the volume to the EM.

Control circuit 40 is programmed to cause generator 30 to generate this field for a preset amount of time. In embodiments, for a tank 20 design to hold 5-gallons of fluid, the time may be 1 second or less or more depending on conditions and the desired effect.

It is understood that the volume capacity of tank 20, the time of processing and the precise characteristics of the PWM waveform may vary. In embodiments where a 5-gallon tank was used, the entire process of filling the tank, processing, and emptying the tank took less than 10 seconds. Thus, the invention employed on even a relatively small (for the liquor and wine making industries) 5-gallon or 8-gallon tank processing system 1 can process a high quantity of liquid over several hours of continuous operation.

### Selected Hardware of an Exemplary Single 5-Gallon Tank System

The inventors of the present invention have implemented the present invention in various embodiments and form factors including small volume, portable, table-top versions, and larger volume, 5-gallon and 8-gallon tanks. It is understood that various sizes and volume capacitances are well within the scope of the present.

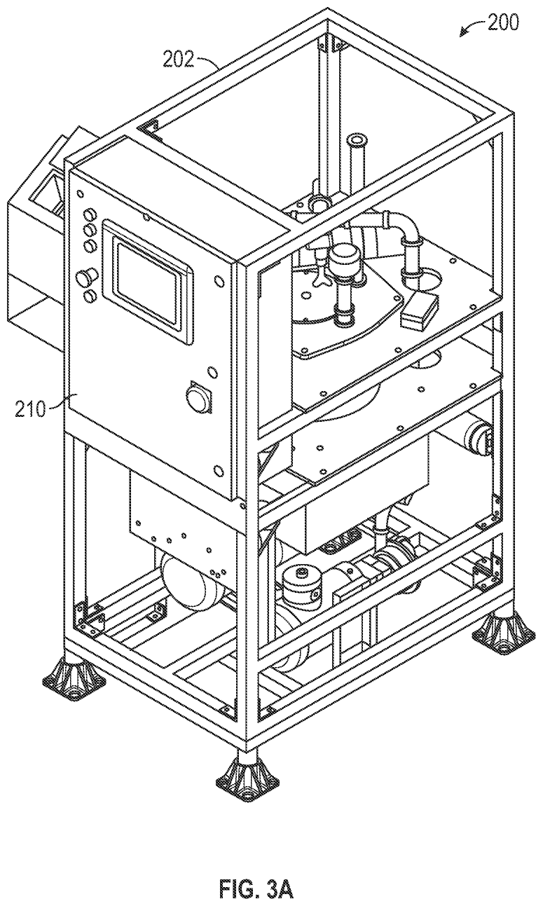

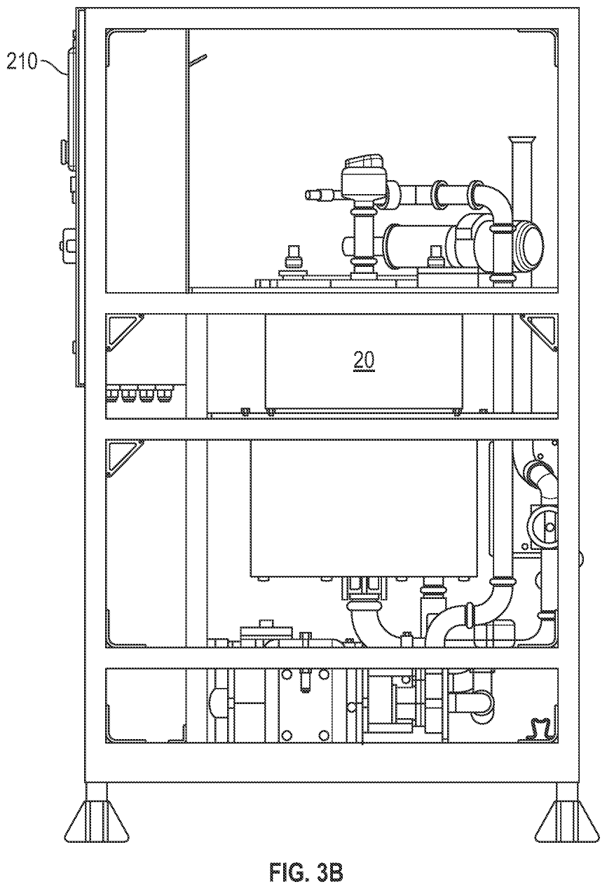

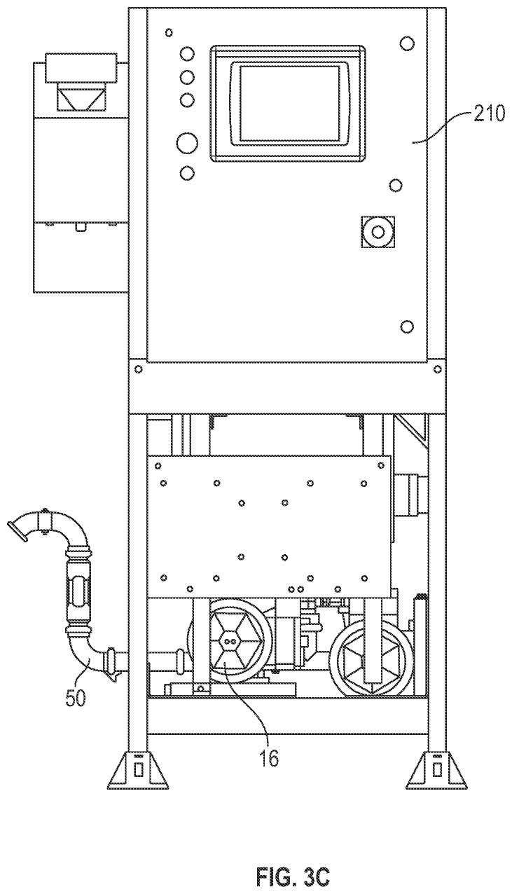

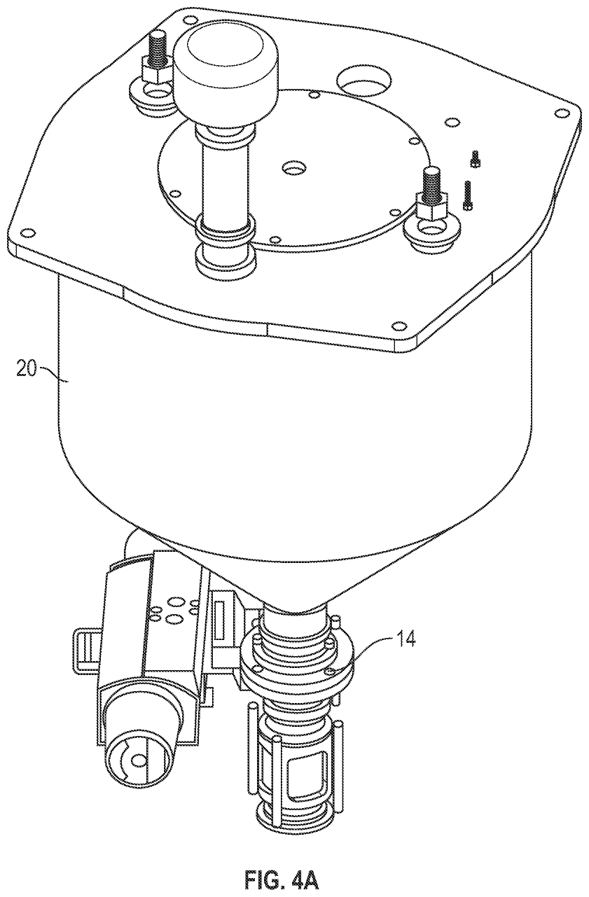

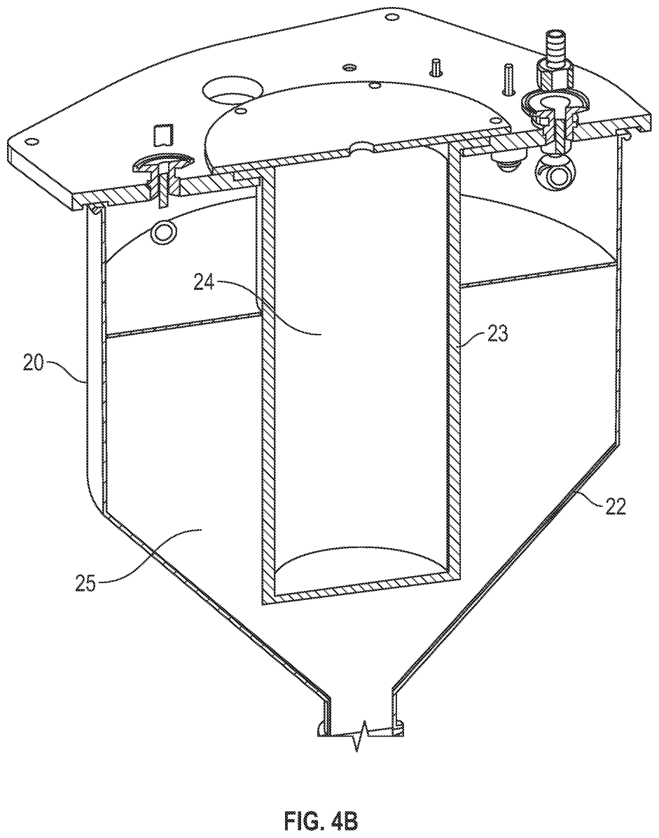

Now shown in FIGS. 3A-3C and FIGS. 4A and 4B is one preferred single tank, 5-gallon embodiment. FIGS. 3A-3C show an assembled processing unit 200 with walls removed. The components are all assembled to frame 202 and include a front control panel 210 which houses control circuitry 40 discussed above. FIG. 3B shows a side view of unit 200 with tank 20 assembled therein. FIG. 3C is a front view of unit 200 showing pump 16 with fluid exit pipe 50 for removing the processed fluid into a holding container (not shown).

FIGS. 4A and 4B show one preferred embodiment of tank 20. As seen in the cutaway view of FIG. 4B, tank 20 has outer wall 22 that serves as one electrode and inner core 24 that is electrically and physically isolated in glass tube 23. Thus, the inner volume 25 of tank 20 may fill with liquid to be processed. When the EM field is generated across electrodes 22, 24, the entire volume can be subjected to the field.

The inventors of the present invention have discovered that there are fundamental frequency and voltage ranges and exposure times for which the invention produces remarkable results, partly depending on the liquid being processed and its volume. In various embodiments, the fundamental frequency of the complex waveform generated is selected from between 1500 Hertz and 50,000 Hertz. For example, in some preferred embodiments, the fundamental frequency of the complex waveform may be between 3000 Hertz and 24,000 Hertz. In preferred implementations, the generated EM has an average voltage between 400 and 1200 volts. In more preferred embodiments, the applied voltage may be closer to 800 volts. The time period for maintaining the waveform field is also variable.

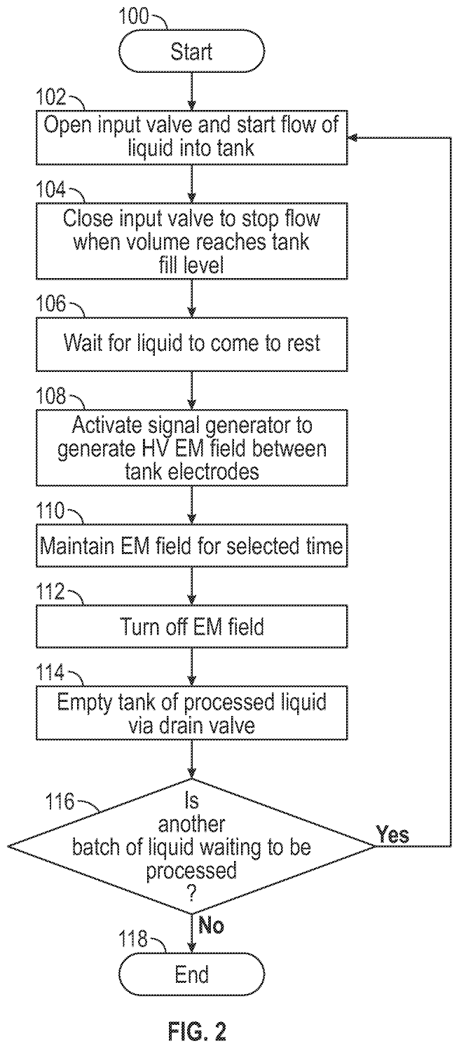

Thus, in the presently preferred example, and by way of example and not limitation, a preferred method of processing the liquid is shown in FIG. 2. After starting the process at step 100, in step 102 input valve 2 is opened allowing liquid to flow into tank 20. At step 104 once the volume reaches a tank fill level as sensed by fill level sensor 26, input valve 2 closes. In step 106, the system waits for the liquid to come to rest. Step 108 has the control circuit 40 activate power EM field generator 30 to generate a high voltage, pulse width modulated EM field having a desired a fundamental frequency and voltage level (and potentially other particular characteristics), which is maintained at step 110 for a selected amount of time. The time may be pre-set into the processor's memory or it may be selectable by a user of the system. The volume being processed is contained in such a way that will allow the electromagnetic field to completely envelope the fluid.

The EM field is turned off in step 112 and in step 114, the tank is emptied of the processed liquid via a drain valve. Then, at decision point-step 116, the processor is informed by a sensor whether or not there is another batch of liquid to process. If there is, steps 102-114 are repeated for the next batch. If there is no follow up batch to process, then in step 118 the process ends.

### Testing

Embodiments of the present invention have been extensively tested on various alcoholic beverages. One set of test results from 2019 demonstrates that the inventive Steric™ method works to significantly break down A-Amyl alcohol components into shorter-chain alcohols, and thereby markedly improving the taste of the beverage. In particular, a volume of Wild Turkey 101™ bourbon whiskey was processed using the method of the present invention and was analyzed by a lab for chemical composition. Table A shows changes to the chemical compositions of numerous components of the Wild Turkey bourbon from its state before processing—the “Control Levels”, to post-processing—“Trial Levels”:

TABLE A

| | CONTROL | TRIAL | % | |
|---|---|---|---|---|
| Test | LEVEL | LEVEL | Change | Mass |
| Acetaldehyde | 33 | 33 | 0.0% | 0 |
| Ethyl Acetate | 423 | 453 | 6.8% | 30 |
| Methanol | 52 | 55 | 5.6% | 3 |
| 1-Propanol | 86 | 86 | 0.0% | 0 |
| 1-Butanol | 481 | 483 | 0.4% | 2 |
| A-Amyl Alcohol | 344 | 314 | −9.1% | −30 |
| I-Amyl Alcohol | 1440 | 1433 | −0.5% | −7 |
| absorbance @ 280 nm | 16.8 | 17.1 | 1.8% | 0.3 |
| trans-Oak Lactone | 688 | 722 | 4.8% | 34 |
| cis-oak Lactone | 4570 | 4742 | 3.7% | 172 |
| Vanillin | 3790 | 3581 | −5.7% | −209 |
| Furfural | 7800 | 7870 | 0.9% | 70 |
| 5-methylfurfural | 515 | 521 | 1.2% | 6 |
| Guaiacol | 73 | 74 | 1.4% | 1 |
| 4-methylguaiacol | 50 | 52 | 3.9% | 2 |
| Eugenol | 267 | 271 | 1.5% | 4 |

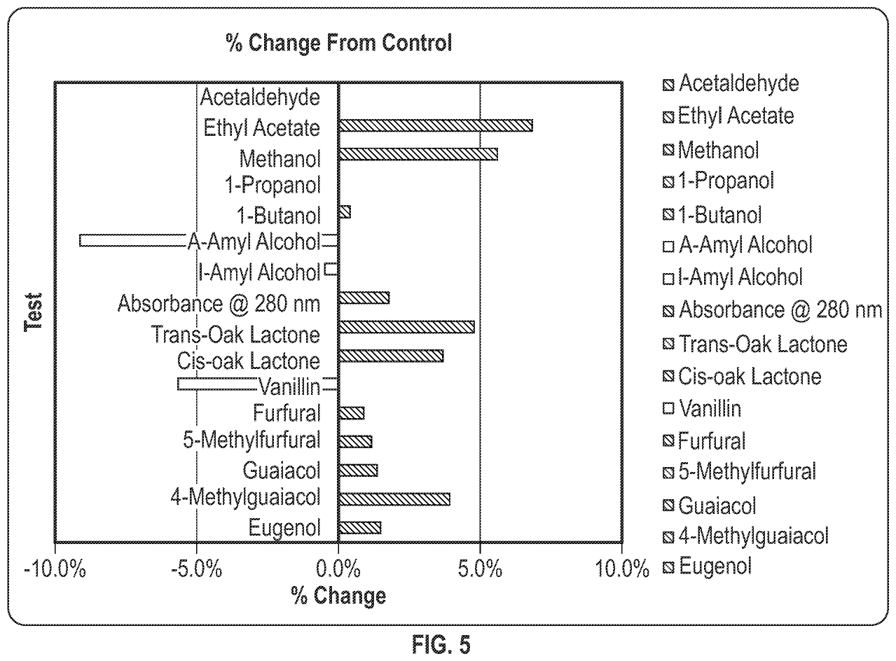

These changes are also shown graphically in FIG. 5. Note the stark reduction in the A-Amyl Alcohol content in the whiskey from the pre-processed (“control”) state to the post-processed (“trial”) state—a more than a 9% reduction.

While embodiments of the invention have been illustrated and described, it is not intended that these embodiments illustrate and describe all possible forms of the invention. Various changes, modifications, and alterations in the teachings of the present invention may be contemplated by those skilled in the art without departing from the intended spirit and scope thereof. It is intended that the present invention encompasses such changes and modifications.

1. A method of processing an alcoholic beverage, comprising:
a. placing a first volume of the beverage in a container having two electrodes, wherein the volume is substantially between the electrodes, with at least one of the electrodes being electrically insulated from the volume;
b. generating an electromagnetic (EM) field between the electrodes to subject the volume to the EM field, wherein the EM field comprises a complex waveform having a pulse-width-modulated fundamental frequency and multiple harmonics derived therefrom; and
c. maintaining the EM field for a certain amount of time.

2. The method of claim 1, further including the step of removing the first volume from the container after the certain amount of time has elapsed.

3. The method of claim 2, further including after the step of removing the first volume, placing a second volume of the alcoholic beverage into the container and repeating steps of generating an EM field and maintaining the EM field on the second volume.

4. The method of claim 1, further including the step of allowing the first volume to substantially come to rest before the step of generating the EM field.

5. The method of claim 1, wherein the two electrodes are electrically insulated from the volume.

6. The method of claim 1, wherein the at least one electrically insulated electrode is a core electrode located substantially in the middle of the container.

7. The method of claim 1, wherein the second electrode is not electrically insulated from the volume and is a wall of the container.

8. The method of claim 1, wherein the EM field generated is a substantially toroidal EM field.

9. The method of claim 1, wherein both electrodes are electrically insulated from the volume.

10. The method of claim 1, wherein the complex waveform has a predetermined pulse-width-modulated fundamental frequency and multiple harmonics derived therefrom.

11. The method of claim 1, wherein the certain amount of time the EM field is maintained on the volume is determined before the step of generating the electromagnetic (EM) field.

12. The method of claim 1, wherein the certain amount of time the EM field is maintained is pre-calculated.

13. The method of claim 1, wherein the certain amount of time the EM field is maintained less than 1 second.

14. The method of claim 1, wherein the beverage is wine and the EM field is maintained for less than 8 seconds.

15. The method of claim 1, wherein the certain amount of time the EM field is maintained is calculated after the first volume is placed in the container and is at least partially based on the volume.

16. The method of claim 13, wherein the certain of time is automatically calculated based at least in part on the volume of beverage that is placed in the container.

17. The method of claim 13, wherein the certain of time is based at least partly on the volume and the kind of alcoholic beverage that is placed in the container.

18. The method of claim 1, wherein the fundamental frequency of the complex waveform is between 1500 Hertz and 50,000 Hertz.

19. The method of claim 1, wherein the generated EM has an average voltage of at least 600 volts.

20. The method of claim 1, wherein the generated EM has an average voltage between 400 and 1200 volts.

21. A method for reducing the A-Amyl alcohol component of a volume of an alcoholic beverage by at least 1.5 percent, the method comprising:
a. placing a first volume of the beverage in a container having two electrodes, wherein the volume is substantially between the electrodes, with at least one of the electrodes being electrically insulated from the volume;
b. generating an electromagnetic (EM) field between the electrodes to subject the volume to the EM field, wherein the EM field has an average voltage between 800 and 900 volts, and comprises a complex waveform having a pulse-width-modulated fundamental frequency between 3 kHz and 25 kHz, and multiple harmonics derived therefrom; and
c. maintaining the EM field for a certain amount of time.

22. The method of claim 21, where the subjecting the volume to the EM field for the set amount of time reduces the A-amyl alcohol content by at least 5 percent.

23. The method of claim 21, wherein the alcoholic beverage is pure grain alcohol.
